(19) United States
(12) Patent Application Publication
(10) Pub. No.: US 2007/0186630 A1
(43) Pub. Date: Aug. 16, 2007

(54) Sensor arrangement and method for producing a sensor arrangement

(76) Inventor: Harry Skarpil, Dortmund (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/587,484

(22) PCT Filed: Apr. 25, 2005
(86) PCT No.: PCT/EP05/51836

§ 371 Date: Oct. 25, 2006

(30) Foreign Application Priority Data
Apr. 28, 2004 (DE) 10 2004 020 858.1

(51) Int. Cl. G01L 3/26

(52) U.S. Cl. 73/115

(57) ABSTRACT

The invention relates to a sensor arrangement (8), comprising a flange component (9), for external fixing of the sensor arrangement (8) and a sleeve (1), for housing electrical components, which is firmly secured to the flange component (9). The invention also relates to a method for producing a sensor arrangement. The air of said invention is to simplify the manufacturing of said sensor arrangement (8). Said air is achieved, whereby the sleeve (1) is arranged in a recess (10) of the flange component (9) and secured to the flange component (9), by means of a friction weld (11). Moreover, the inventive method comprises the steps of inserting a flange component into a welding housing, introducing a cylindrical sleeve with clearance into a recess of the flange component, inserting a plunger into the sleeve such as to expand said sleeve in the area of the inner wall of the recess, which results in a radial compression of the sleeve and flange component and offsetting the sleeve and flange component in relation to each other by a relative rotation, whereby the sleeve and flange component are friction welded.

The invention relates to a sensor arrangement having a flange component for externally fastening the sensor arrangement and having a sleeve firmly connected to the flange component for receiving electrical components. The invention furthermore relates to a method for producing a sensor arrangement.

A sensor arrangement is known in the form of an inductive tachometer having a housing, which receives electrical components, with a first housing part which is partially enclosed by a second housing part produced from plastic in an injection molding process, a tight connection being achieved in the contact zone of the two housing parts. In the first housing part, which is designed in the form of a cup, a coil carrier is fitted with a coil having contact pins and conductors. A flange component for externally fastening the tachometer is not provided.

A device is furthermore known for detecting the rotational speed of a revolving component, with a sampling instrument operating electrically for contactlessly sampling the revolving component and an instrument for signal processing the signals delivered by the sampling instrument to form an output signal proportional to the rotational speed. The individual components are arranged in plastic half-shells around which injection moldings are made forming a one-piece closed injection-molded housing. A fastening flange is injection-molded onto the housing in the injection molding process.

U.S. Pat. No. 5,504,424 A discloses a sensor arrangement of the type mentioned in the introduction, in which the sleeve is introduced into a recess of the flange component until it abuts on a stop and is held with a press fit in the recess.

DE 199 47 437 A1 discloses a sensor arrangement of the type mentioned in the introduction, in which one end region of the sleeve is inserted into a cup-shaped recess of the flange component until it abuts on the bottom of the cup-shaped recess and is then welded by means of the laser welding.

For sensor modules, it is known from DE 101 45 679 A1, DE 44 19 902 A1, and WO 2004/020961 A to connect housing parts to one another by friction welding.

It is an object of the invention to provide a sensor arrangement of the type mentioned in the introduction, which comprises a simple and secure connection of the flange component to the sleeve. It is also an object of the invention to provide a method for producing a sensor arrangement having such a flange component and such a sleeve.

The former object is achieved according to the invention in that the sleeve is designed as a cup with a closed bottom and inserted in a recess of the flange component up to a freely adjustable function length, and is connected to the flange component by means of a friction weld.

The invention advantageously offers a very stable and durable connection of the sleeve and the flange component, which is also inexpensive to manufacture. In this way, the sensor arrangement according to the invention is also suitable particularly for mass production, for example as is required in motor vehicle manufacture. For friction welding, parts are generally pressed together in a high-speed turning device, one part being held stationary while the other rotates; after sufficient heating, the force fit of the drive is released and the parts are connected to one another by pressure. Owing to the high mechanical load-bearing capacity of the connection, the sensor arrangement according to the invention is advantageously usable in motor vehicles since it allows the oscillating loads constantly occurring in them, inter alia due to vibrations when driving, to be withstood well and durably.

The bottom achieves unilateral closure of the sleeve, and the electrical sensor components to be received in the sleeve are protected particularly well against environmental effects, particularly humidity.

The sleeve can be inserted into the recess of the flange over a length predetermined by the welding holder, which very straightforwardly allows production of sensor arrangements with sleeves having different active lengths in a single production plant.

For example, it is feasible for friction welding of the sleeve and the flange component to take place as a result of vibrating axial movements of the two components against one another. For simple and secure welding, however, it is advantageous for the recess to have a circular cross section and for the sleeve to have a cylindrical contour, so that welding can take place by means of a rotary movement of the parts against one another. According to an advantageous refinement of the invention, the outer diameter of the sleeve is less than the inner diameter of the recess so as to provide clearance. In this way, the sleeve can readily be inserted over a predetermined length into the recess.

Controlled local friction of the components with one another, and therefore defined welding, can be achieved according to an advantageous refinement of the invention in that the sleeve has a protuberance on its circumference facing the inner wall of the recess, and in that the friction weld is arranged in the region of the protuberance.

To further reduce the production costs of the sensor arrangement and to additionally reduce any possible corrosion risk, according to another advantageous refinement of the invention the sleeve and the flange component consist of a plastic at least in the region of the friction weld. This also simplifies the friction welding.

Automatic assembly as well as the friction welding of the sleeve and the flange component are facilitated when, according to an advantageous refinement of the invention, the sleeve has a circumferential chamfer on its inner wall at an open end. In this way, for example, it is easier to insert a plunger or a finger moving the sleeve in the manufacturing process.

In principle, the sensor arrangement according to the invention may be designed to record any quantities, particularly physical quantities. According to an advantageous refinement of the invention, however, the electrical components are components of a sensor, particularly a Hall probe or a temperature sensor or an inductive probe. Such sensors, which are typically used in motor vehicles, require regular as well as secure function under robust environmental effects and should also be producible inexpensively. These requirements are fulfilled particularly well by a sensor arrangement according to the invention.

The object mentioned second above is achieved by a method wherein, sequentially, a flange component is put into a welding holder, a cylindrical sleeve is inserted with clearance into a recess of the flange component, a plunger is driven into the sleeve so as to widen it in the region of the inner wall of the recess, radial compression of the sleeve and the flange component taking place, and a relative rotation with respect to one another is imparted to the sleeve and the flange component, so that friction welding of the sleeve and the flange component takes place. Reliable and simple production of the sensor arrangement is provided in this way. The method is suitable particularly for producing a sensor arrangement according to the invention as described above.

According to an advantageous refinement of the invention, the sleeve is inserted into the recess over a length predetermined by the welding holder. This very straightforwardly allows production of sensor arrangements with sleeves of different active lengths in a single production plant.

Exemplary embodiments of the invention are represented in the drawing and will be explained in more detail below.

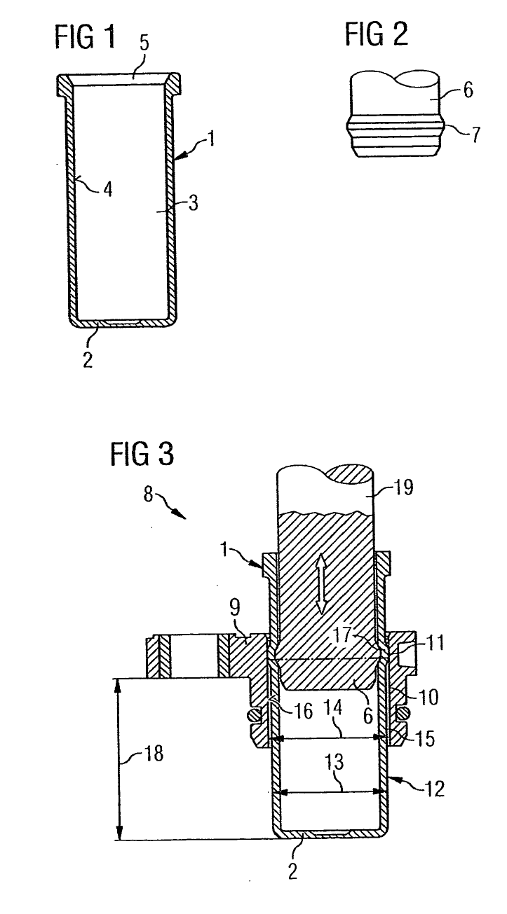

FIG. 1 shows a sleeve for a sensor arrangement,

FIG. 2 shows a head of a plunger for producing a sensor arrangement,

FIG. 3 shows a first sensor arrangement,

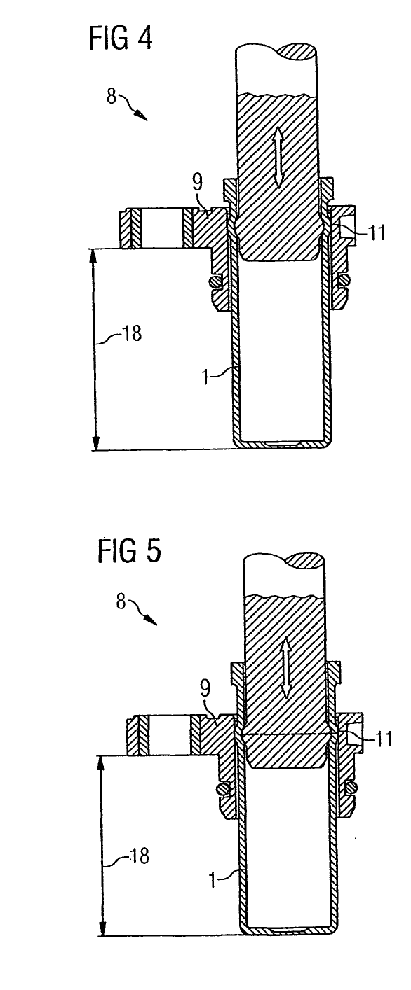

FIG. 4 shows a second arrangement, and

FIG. 5 shows a third sensor arrangement.

Components which correspond to one another are respectively provided with the same reference numerals in the figures.

FIG. 1 shows a sectional side view of a sleeve 1 designed as a cup for a sensor arrangement. The sleeve 1 is used to receive electrical sensor components (not further represented here) and is provided with a circumferential chamfer 5 on its inner wall 4 at its open end 3 remote from the bottom 2. The chamfer 5 is used to facilitate insertion of a plunger during production of the sensor arrangement.

FIG. 2 shows a head 6 of a corresponding plunger in a side view. The head 6 has a bracing support 7 designed as a circumferential rib.

A first sensor arrangement 8 is represented in a sectional side view in FIG. 3. The sensor arrangement 8 comprises a flange component 9 for externally fastening the sensor arrangement 8 (for example on a chassis of a motor vehicle) and a sleeve 1 for receiving sensor components (not further represented here). The sleeve 1, which has a cylindrical contour 12, is designed as a cup with a closed bottom 2 and is arranged in a circular recess 10 of the flange component 9. A firm connection of the sleeve 1 and the flange component 9, both of which are plastic components, is obtained by means of a friction weld 11.

The outer diameter 13 of the sleeve 1 is less than the inner diameter 14 of the recess 10 so as to leave a clearance 15 between the two components, which is bridged by the friction weld 11. The sleeve 1 has a protuberance 17 on its circumference facing the inner wall 16 of the recess 10, and the friction weld is arranged in the region 18 of the protuberance 17.

When producing the sensor arrangement 8, the flange component 9 is put into a welding holder. The sleeve 1 is subsequently inserted into the recess 10 of the flange component 9 with a clearance fit. The welding holder provides a freely adjustable function length 18 of the sensor arrangement 8, which function length 18 is given by the distance of the bottom 2 of the sleeve 1 from a reference surface of the flange component 9. A conical plunger 19 with its head 6 having a bracing support 7 is subsequently inserted into the sleeve 1. The outer diameter of the plunger 19 is only slightly less than the inner diameter of the sleeve 1. Compression of the sleeve 1 and the flange component 9 takes place owing to the diametral widening of the sleeve 1 achieved by means of the bracing support 7. By a relative rotational movement of the sleeve 1 and the flange component 9 with respect to one another, the two components are welded in the region of the friction surfaces.

A second sensor arrangement 8 having a flange component 9 and a sleeve 1 comprising a bottom 2 is shown in FIG. 4, the sleeve 1 and the flange component 9 being connected by means of a friction weld 11. Compared with the exemplary embodiment according to FIG. 3, the function length 18 of the sensor arrangement 8 is greater here.

A third sensor arrangement 8 according to FIG. 5 has a medium function length 18. Here again, a friction weld 11 connects a flange component 9 to a sleeve 1.

The various exemplary embodiments according to FIGS. 3 to 5, which differ merely in the function length, make it clear that the function length depends exclusively on the tool (welding holder) used when producing the sensor arrangement, but not on the design configuration of the connected components, i.e. sleeve and flange component. With the same components, it is therefore possible to produce arbitrary function lengths (within the length of the sleeve). It is furthermore conceivable to align a plug connector as a function of the position of the sleeve.

1-10. (canceled)

11. A sensor arrangement comprising:
a flange component for externally fastening the sensor arrangement, the flange component defining a recess; and
a cup-shaped sleeve with a closed bottom for receiving electrical components, the sleeve being inserted in the recess of the flange component such that the sleeve is freely adjustable in the recess along a functional length of the sleeve and being firmly connected to the flange component by a friction weld at a desired position along the functional length.

12. The sensor arrangement of claim 11, wherein the recess has a circular cross section and the sleeve has a cylindrical contour.

13. The sensor arrangement of claim 12, wherein the sleeve has an outer diameter and the recess has an inner diameter, the outer diameter of the sleeve being smaller than the inner diameter of the recess to provide a clearance.

14. The sensor arrangement of claim 11, wherein the recess has an inner wall and the sleeve has a region with a protuberance on a circumference facing the inner wall of the recess, the friction weld being arranged in the region with the protuberance.

15. The sensor arrangement of claim 11, wherein the sleeve and the flange component consist of a plastic at least in a region of the friction weld.

16. The sensor arrangement of claim 11, wherein the sleeve has an inner wall, an open end and a circumferential chamfer on the inner wall at the open end.

17. The sensor arrangement of claim 11, wherein the electrical components are components of a Hall probe, a temperature sensor or an inductive probe.

18. A method for producing a sensor arrangement, comprising the steps of:
putting a flange component with an inner wall defining a recess into a welding holder;
inserting a cylindrical sleeve with a clearance into the recess of the flange component, the sleeve being freely adjustable in the recess along a functional length of the sleeve;
inserting a plunger into the sleeve so as to widen the sleeve toward the inner wall of the recess, thereby compressing the sleeve and the flange component in a radial direction; and
performing a relative rotation between the sleeve and the flange component so that a friction welding of the sleeve and the flange component takes place.

19. The method of claim 18, wherein the step of inserting the sleeve into the recess comprises inserting the sleeve into the recess over a length predetermined by the welding holder.
